(19) United States
(12) Patent Application Publication
(10) Pub. No.: US 2026/0352143 A1
(43) Pub. Date: Nov. 5, 2026

(54) PHOTOVOLTAIC MODULE MOUNTING CLIP

(71) Applicant: ARRAY TECH, INC., Albuquerque, MN (US)

(72) Inventor: Anuja Daiv, Chandler, AZ (US)

(21) Appl. No.: 19/652,509

(22) Filed: Apr. 20, 2026

Related U.S. Application Data
(60) Provisional application No. 63/792,523, filed on Apr. 22, 2025.

(51) Int. Cl. H02S 20/32

(52) U.S. Cl. CPC H02S 20/32

(57) ABSTRACT

A clip for coupling a mounting rail to PV modules may include a first surface, a second surface, and an edge extending between the first and second surfaces. The second surface may include a first end protrusion, a second end protrusion, and a central protrusion positioned between the first and the second end protrusions. An aperture may extend through the first surface and the central protrusion. The first and second end protrusions may be respectively configured to inhibit movement of a first module rail of a first PV module and a second module rail of a second PV module. The central protrusion may be configured to couple the clip to the mounting rail. Channels may be defined by the second surface between each end protrusion and the central protrusion. Each channel may be configured to engage a separate apertural surface of the first and second module rails.

### CROSS-REFERENCE TO RELATED APPLICATIONS

This patent application claims priority to and the benefit of U.S. Provisional Patent Application Ser. No. 63/792,523, entitled PHOTOVOLTAIC MODULE MOUNTING CLIP, filed Apr. 22, 2025, which is incorporated by reference in its entirety.

### FIELD

The present disclosure relates to solar energy production and more particularly to a photovoltaic (PV) module mounting clip and a system that uses the clip.

### BACKGROUND

Solar installations including solar farms, photovoltaic (PV) plants, solar tracking systems, fixed solar systems, and other PV systems often include large numbers of PV modules that collect sunlight and generate energy. Solar tracker systems typically include multiple solar tracker rows and operate by rotating photovoltaic (PV) modules secured to each solar tracker row to align the PV modules with the position of the Sun. As a result, the PV modules' exposure to sunlight throughout the day may be increased. This functionality may ensure that PV modules in solar tracker systems remain positioned to capture higher levels of solar radiation, which may enhance the overall efficiency of solar power generation.

Each solar tracker row may include one or more PV modules and a torque tube. The torque tube may provide horizontal support to the PV modules and may be coupled to the PV modules such that rotation of the torque tube rotates the PV modules. The torque tube may be supported by support structures or piles, which may be placed at varying distances along the row to provide vertical support for the torque tube and the PV modules.

To facilitate the mounting of a PV module to the torque tube, a mounting rail may be coupled to a torque tube and may be coupled to a module rail of the PV module via a clip. For example, the module rail of the PV module may have a hole that may be configured to receive the clip such that the module rail may be coupled to the mounting rail. In some instances, multiple PV modules may be coupled to a single mounting rail via a clip. For example, one side of the clip may couple the mounting rail to a module rail of a first PV module and a second side of the clip may couple the mounting rail to a module rail of a second PV module.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Solar tracking systems may undergo significant forces during operation, which may cause clips coupling module rails and mounting rails to fail. For example, solar tracking systems may be installed in locations where high-wind events are common. During high-wind events, the PV modules may start to gallop (e.g., oscillate at a low frequency). The repeated upward and downward movement of the PV modules during galloping may cause the clips to weaken, bend, and/or break. Additionally, the clip may experience significant vibration during galloping. The vibration may cause the clip to loosen from the mounting rail and/or rotate into edges of the module rail holes, which may damage the module rails. Furthermore, galloping may cause the module rail of a PV module to slip off the mounting rail, which may expose the end of the clip to a significant portion of the weight of the PV module. As a result, the clip may fail.

As discussed above, clip failures may cause damage to the PV modules. For example, a clip breaking may cause the PV module to uncouple from the torque tube and fall to the ground, which may cause the protective glass of the PV module to break and/or may damage the solar cells in the PV module. In addition, clip failures may lead to safety risks, loss of energy production, and/or downtime in replacing the clips.

The clips may also present challenges during normal installation and operation. For example, the clips may be torqued during installation, which may cause the clips to rotate into the surface of the holes in the module rails. As a result, the module rails may be damaged during operation of the solar tracking system due to the contact between the clip and the surfaces of the holes in the module rail. Furthermore, the module rail may be installed toward the edge of the mounting rail, and the module rail may slip off the mounting rail over time. As mentioned previously, this may cause the clip to weaken, bend, and/or break due to the weight of the PV modules.

Additionally, clips may increase PV module installation time by several seconds because clips may need to be lifted up by hand in order to align the clip with the holes in the module rails. Because PV systems may include thousands to hundreds of thousands of PV modules, these additional seconds may add days or weeks to the installation process.

In PV systems, clips typically utilized to couple a PV module to a mounting rail may have a uniform thickness, which may make the clips more prone to bending. Furthermore, the clips may be coupled to the mounting rail via a threaded fastener and the uniform thickness may limit the thread engagement area with the fastener, which may make the clips more prone to loosening and rotation due to loads during operation and/or installation. Clips currently utilized also do not have any capability to help maintain the module rail of the PV module on the mounting rail. Additionally, clips are typically made using a stamping process, which may introduce internal stresses and thinning in certain areas. These defects may lead to a reduced structural integrity of the clip and/or an early failure under the loads associated with a PV system.

Accordingly, there exists a need for improved clips that may resist vibration loosening, resist rotation to reduce damage to the PV module, help retain the module rail of the PV module on the mounting rail, and/or simplify the installation of the PV modules.

Exemplary embodiments of the present disclosure address problems experienced in conventional clips utilized in PV systems, including vibration loosening, unintentional clip rotation, PV module slippage, and/or installation efficiencies. Embodiments disclosed herein may address the above-identified problems by providing a clip having a non-uniform thickness, one or more retention features to limit the movement of the PV module, increased thread engagement, and/or ends that may guide the clip into the module rails during installation. The clip may include protrusions at each end of the clip that may be configured to inhibit movement of the module rails of the PV modules that may be coupled to the clip. The clip may include a central protrusion that may be configured to couple the clip to the mounting rail. The central protrusion may have an increased thickness compared to the rest of the clip. The central protrusion may include an aperture having threads, which may result in increased thread engagement. The central protrusion may be positioned between the protrusions at each end of the clip such that channels may be defined between the end protrusions and the central protrusion. The channels may engage an apertural surface of the module rails coupled to the clip, which may help inhibit movement of the module rails relative to the mounting rail.

In some embodiments, the protrusions may be rounded (e.g., circular), which may limit the damage caused to the module rails if the clip begins to rotate. In some embodiments, the clip may include an edge that tapers inwardly at each end of the clip such that the clip is narrower at the ends than a central portion of the clip, which may guide the clip into apertures of the module rails.

Additionally, in some embodiments, the clip may be manufactured using a forging process. The forging process may use one or more dies to shape a metal workpiece into a clip under high temperatures, which may modify the grain structure of the clip, increase density, minimize porosity, and/or reduce internal stresses of the clip such that the clip may be stronger and less prone to failure than traditional clips.

Overall, the embodiments disclosed may improve PV systems by providing a clip to couple one or more PV modules to a mounting rail that may be less prone to failures due to the loads experienced in a PV system. For example, the clip may reduce PV module slippage, vibrational loosening, unintentional rotation, and/or may be stronger than clips traditionally utilized in PV systems. Additionally, the clip may be easier to install, which may result in hours, days, and even weeks of saved labor time.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example PV system;

FIG. 2A and FIG. 2B respectively illustrate a perspective view of an example mounting assembly coupled to module rails and an exploded view of the example mounting assembly and the module rails;

FIG. 2C and FIG. 2D respectively illustrate a perspective view and an exploded view of the example mounting assembly of FIGS. 2A and 2B;

FIG. 2E and FIG. 2F respectively illustrate an end-view and a side-view of the example mounting assembly of FIGS. 2A and 2B coupled to the module rails of FIGS. 2A and 2B;

FIG. 3A and FIG. 3B illustrate various perspective views of an example clip; and

FIG. 4 is a flowchart of an example method of manufacturing a clip for coupling a mounting rail to PV modules.

All in accordance with one or more embodiments in the present disclosure.

### DETAILED DESCRIPTION

Embodiments of the present disclosure are explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

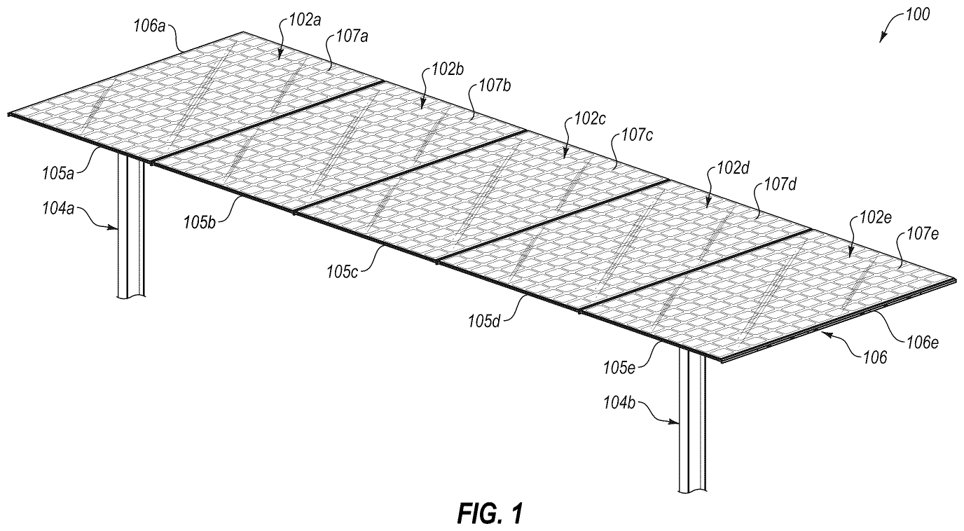

FIG. 1 illustrates an example PV system 100. The PV system 100 may include one or more PV modules 102. The PV system 100 may also include one or more support columns (or piles) 104, and a torque tube (not shown). The PV modules 102 may be coupled to the torque tube such that the rotation of the torque tube may be translated to the PV modules 102 enabling the PV modules 102 to track the position of the Sun in the sky throughout the day. For example, as the Sun rises and early in the day, the PV modules 102 may be rotated by the torque tube such that the PV modules 102 may be facing an easterly direction, around mid-day the PV modules 102 may be rotated by the torque tube such that the PV modules 102 may be substantially horizontal, and as the Sun sets and later in the day, the PV modules 102 may be rotated by the torque tube such that the PV modules 102 may be facing a westerly direction. Additionally or alternatively, the PV modules 102 may be rotated by the torque tube in response to weather events such as hailstorms or snowstorms, for maintenance purposes, and/or in response to other factors other than to track the position of the Sun.

The support columns 104 may be driven into the ground and may provide vertical support for the PV modules 102 and the torque tube. The torque tube may provide horizontal support to the PV modules 102, and the torque tube may be rotated by a motor (not shown). The support columns 104 may be placed at varying frequencies in the PV system 100. For example, the PV system 100 may include a first support column 104a and a second support column 104b. As illustrated in FIG. 1, in some instances, there may be more PV modules 102 than support columns 104.

The PV modules 102 may include a frame 105 and a solar panel 107. For example, a first PV module 102a may include a first frame 105a and a first solar panel 107a, a second PV module 102b may include a second frame 105b and a second solar panel 107b, a third PV module 102c may include a third frame 105c and a third solar panel 107c, a fourth PV module 102d may include a fourth frame 105d and a fourth solar panel 107d, and a fifth PV module 102e may include a fifth frame 105e and a fifth solar panel 107e.

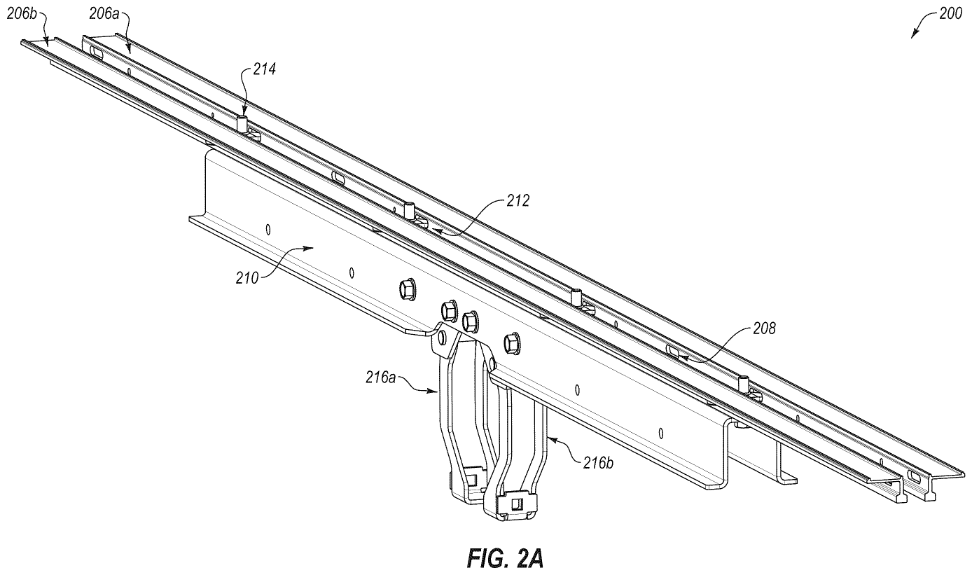

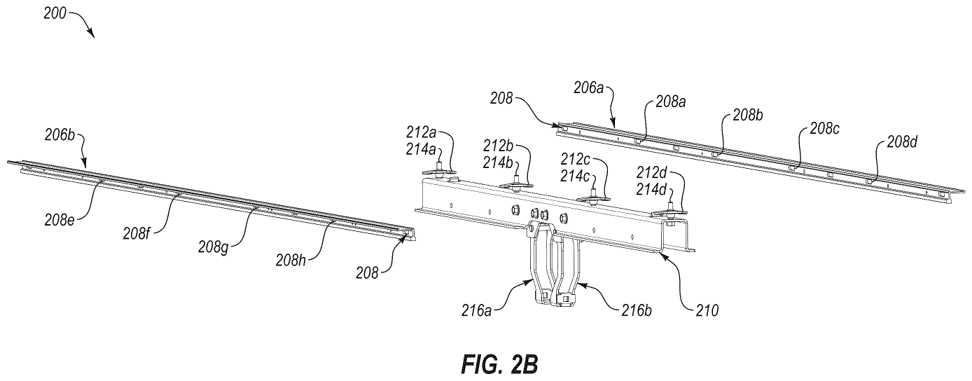

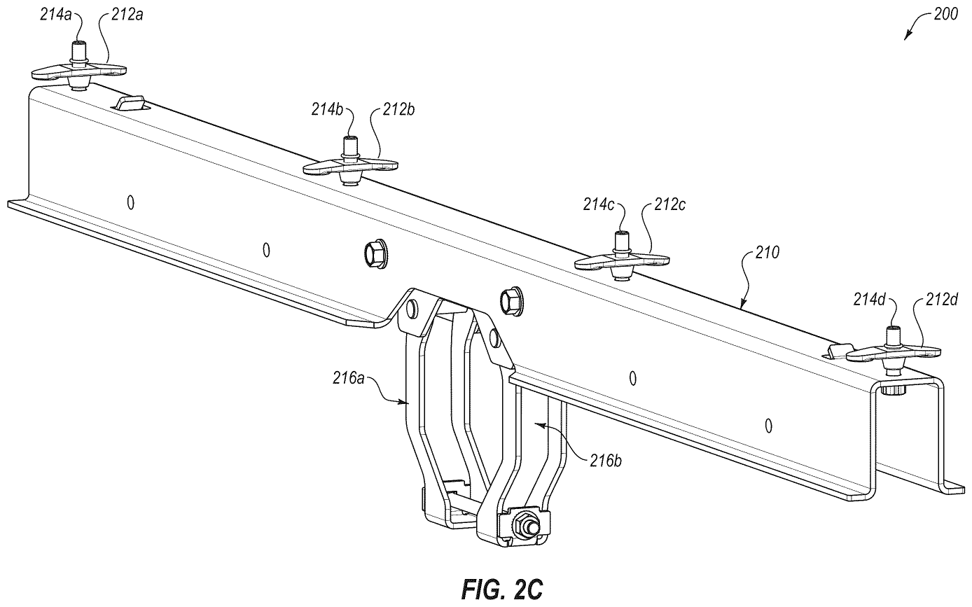

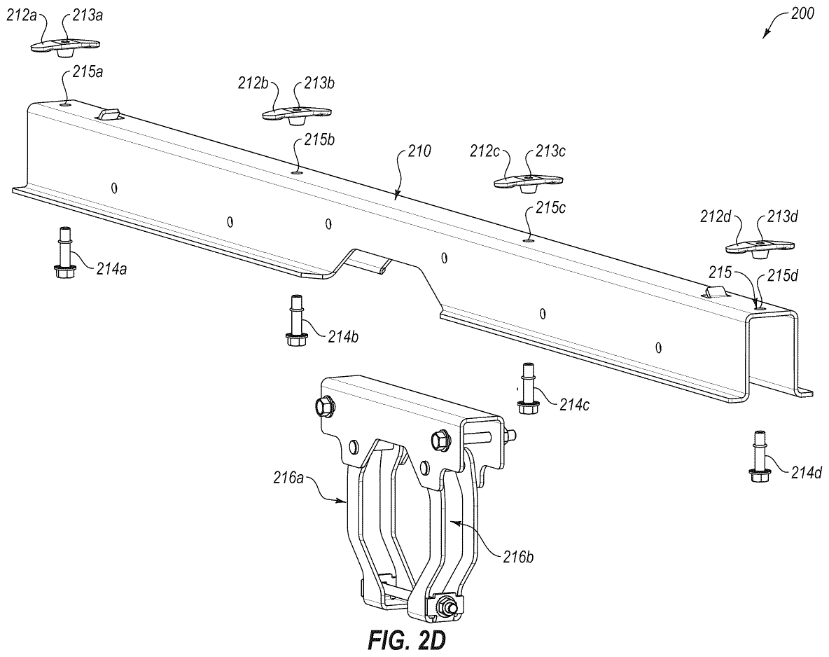

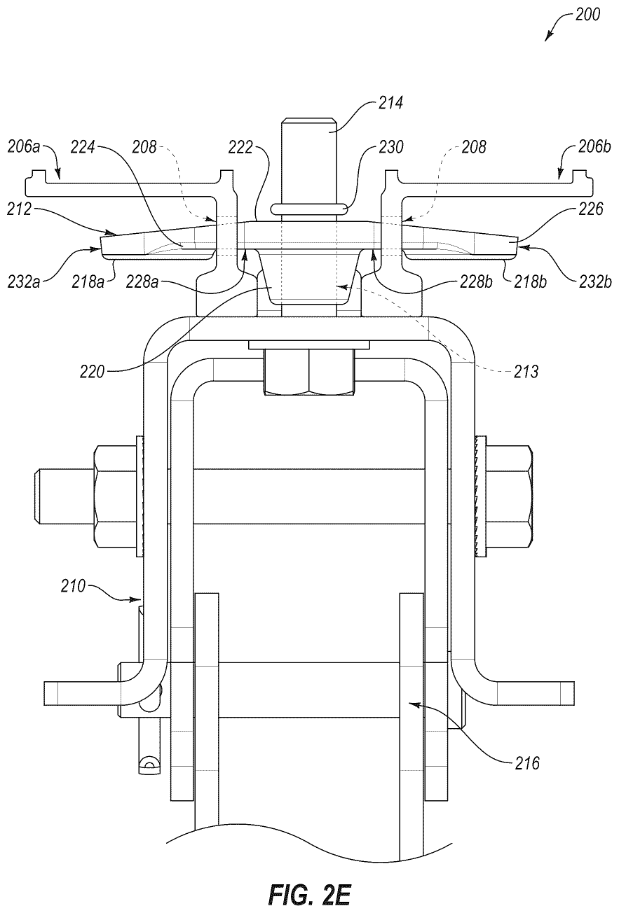

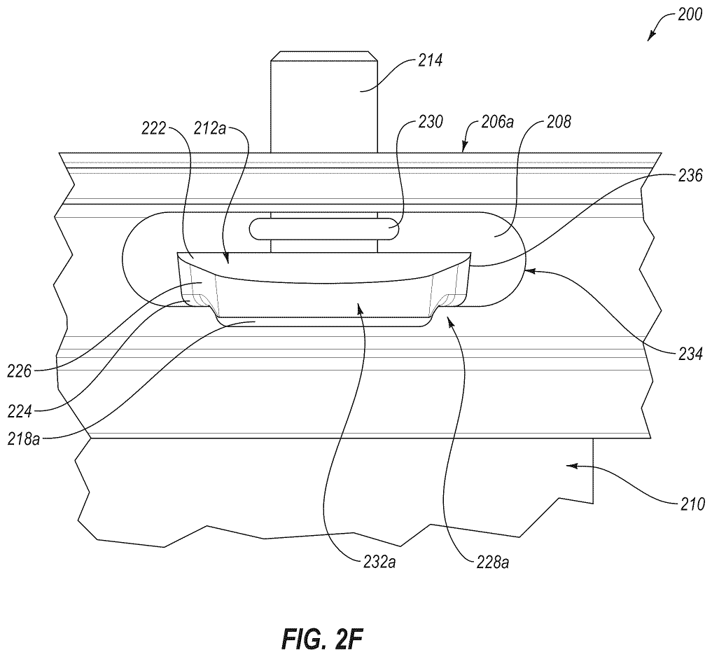

Each frame 105 may be coupled to a solar panel 107 such that the frame 105 may provide structural support for the solar panel 107. In some embodiments, each PV module 102 may be coupled to the torque tube via a mounting rail (not shown). For example, the first PV module 102a and the second PV module 102b may be coupled to a first mounting rail, the second PV module 102b and the third PV module 102c may be coupled to a second mounting rail, the third PV module 102c and the fourth PV module 102d may be coupled to a third mounting rail, and the fourth PV module 102d and the fifth PV module 102e may be coupled to a fourth mounting rail. Thus, each mounting rail may couple multiple PV modules 102 to the torque tube. The mounting rails are described in more detail with respect to FIGS. 2A-2F.

In some embodiments, the PV modules 102 may include one or more module rails 106. In some embodiments, the module rails 106 may be included in the frames 105 of the PV modules 102. For example, each frame 105 may include a module rail 106 at a first end of the frame 105 and at a second end of the frame 105. In these and other embodiments, the module rails 106 may also be referred to as frame rails. In some embodiments, the module rails 106 may be separate from the frame 105. For example, the PV module 102 may include one or more module rails 106 coupled to the bottom of the PV module 102 instead of at the edges of the PV modules, as shown in FIG. 1.

Regardless of their locations, module rails 106 of the PV modules 102 may be coupled to a mounting rail via one or more clips (not shown). For example, the first PV module 102a and the second PV module 102b may be coupled to the first mounting rail via a first clip, the second PV module 102b and the third PV module 102c may be coupled to the second mounting rail via a second clip, the third PV module 102c and the fourth PV module 102d may be coupled to the third mounting rail via a third clip, and the fourth PV module 102d and the fifth PV module 102e may be coupled to the fourth mounting rail via a fourth clip. In some embodiments, and as illustrated in FIGS. 2A-2F, the module rails 106 may be coupled to a mounting rail using multiple clips.

Each module rail 106 may include one or more apertures that may be sized and configured to receive a clip to couple the module rail 106 to a mounting rail. The clips may be sized and configured to engage the apertures of the module rails 106 such that the PV modules 102 may be installed without having to lift the clip. The clips are described in more detail with respect to FIGS. 2-4.

In an example operation of the PV system 100, the PV modules 102 may be rotated by the torque tube to track the position of the Sun as the Sun moves across the sky throughout the day or the PV modules 102 may be rotated by the torque tube for other purposes (e.g., due to an impending hailstorm). During operation of the PV system 100, the clips coupling the PV modules 102 to the torque tube via the mounting rail may undergo significant loads. For example, as discussed previously, there may be less support columns 104 than PV modules 102. Thus, a significant portion of the weight of the PV modules 102 may be experienced by the clips.

Furthermore, weather events such as snow and/or wind may increase the forces on the clips. For example, snow may accumulate on the PV modules 102, which may increase the gravitational force applied to the clips. In another example, wind events may cause galloping (e.g., oscillations in row of PV modules 102), which may lead to increased vibrational forces and/or upward and downward forces as a result. The loads experienced due to these weather events may influence the PV module rails to slip off the mounting rail.

However, as described with reference to FIGS. 2-4, because the clips may be a nonuniform thickness, may offer increased thread engagement with the mounting rail, may be manufactured using a forging process, and/or may include module retention features, among other features, the clips may withstand the loads experienced during normal operation of the PV system 100 and the increased loads experienced during weather events. As a result, the reliability, operational efficiency, and/or safety of the PV system 100 may be improved.

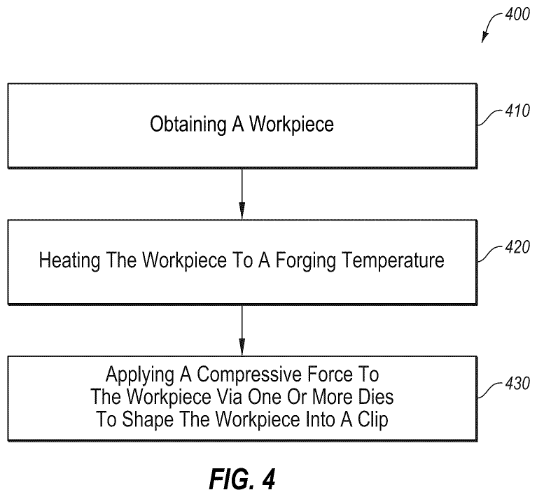

Modifications, additions, or omissions may be made to the PV system 100 without departing from the scope of the present disclosure. For example, a higher number or a lower number of PV modules 102 and/or support columns 104 may be used in the PV system 100. For instance, a third support column may be used in the PV system 100. The support columns 104 may be spaced apart at equivalent distances and/or varying distances depending on the configuration of the PV system 100. In some embodiments, the clips may be manufactured via forging such as through the method 400 described with respect to FIG. 4. In some embodiments, the clips may be manufactured via stamping, casting, injection molding, or other suitable manufacturing processes.

In some embodiments, the clip may be used at a final PV module 102 in a row of PV modules 102 as the ends of the rows of PV modules 102 may experience the highest forces due to galloping. For example, the clip may be used to couple the first PV module 102a and the second PV module 102b, and/or may be used to couple the fourth PV module 102d and the fifth PV module 102e, but different clips may be used to couple the PV modules 102 in the middle of the row that are not coupled to a PV module 102 at either end of the row.

FIGS. 2A-2F respectively illustrate various views of an example mounting assembly 200 that may be used in a PV system such as the PV system 100 described with respect to FIG. 1. For example, the mounting assembly 200 may be coupled to one or more module rails 206 of a PV module such as the PV modules 102 described with respect to FIG. 1.

The mounting assembly 200 may include a mounting rail 210, and the mounting rail 210 may include one or more fasteners 214. The mounting assembly 200 may further include one or more clips 212, and each clip 212 may be coupled to the mounting rail 210 via a fastener 214. For example, as illustrated in FIG. 2B, a first clip 212a may be coupled to the mounting rail 210 via a first fastener 214a, a second clip 212b may be coupled to the mounting rail 210 via a second fastener 214b, a third clip 212c may be coupled to the mounting rail 210 via a third fastener 214c, and a fourth clip 212d may be coupled to the mounting rail 210 via a fourth fastener 214d.

The mounting rail 210 may be coupled to one or more module rails 206 via the clips 212. For example, the mounting rail 210 may be coupled to a first module rail 206a of a first PV module such as the first PV module 102a of FIG. 1 and a second module rail 206b of a second PV module such as the second PV module 102b described with respect to FIG. 1. The module rails 206 may include one or more module rail apertures 208 that may be defined by an apertural surface. For example, as illustrated in FIG. 2B, the first module rail 206a may include module rail apertures 208a-208d, which may each be defined by an apertural surface, and the second module rail 206b may include module rail apertures 208e-208h, which may each be defined by an apertural surface. The module rail apertures 208 may be sized and configured to receive the clips 212. In some embodiments, each clip 212 may be sized and configured to engage an apertural surface of the module rail apertures 208 such that movement of the module rails 206 may be inhibited.

In some embodiments, and as illustrated in FIGS. 2A and 2B, each module rail 206 may include multiple module rail apertures 208. For example, the first module rail 206a may include a first module rail aperture 208a, a second module rail aperture 208b, a third module rail aperture 208c, and a fourth module rail aperture 208d, and the second module rail 206b may include a fifth module rail aperture 208e, a sixth module rail aperture 208f, a seventh module rail aperture 208g, and an eighth module rail aperture 208h. Continuing the example, the first module rail aperture 208a and the fifth module rail aperture 208e may be sized and configured to receive a first clip 212a, the second module rail aperture 208b and the sixth module rail aperture 208f may be sized and configured to receive a second clip 212b, the third module rail aperture 208c and the seventh module rail aperture 208g may be sized and configured to receive a third clip 212c, and the fourth module rail aperture 208d and the eighth module rail aperture 208h may be sized and configured to receive a fourth clip 212d.

As illustrated in FIG. 2A-2E, the mounting assembly 200 may include one or more straps 216. The straps 216 may couple the mounting rail 210 to a torque tube. For example, a first strap 216a and a second strap 216b may collectively define a space that may accommodate a torque tube, and the straps 216 may be tightened against the torque tube such that the mounting assembly 200 and the PV modules coupled to the mounting assembly 200 may rotate as the torque tube rotates.

As mentioned previously, in some embodiments, the mounting rail 210 may include the fasteners 214. In some embodiments, the fasteners 214 may be bolts (e.g., carriage bolts, hex bolts, among other types of bolts), screws, studs, rivets, pins, and/or other suitable fasteners 214. As illustrated in FIG. 2D, in some embodiments, the mounting rail 210 may include one or more mounting rail apertures 215 that may be sized and configured to receive the fastener 214. For example, a first mounting rail aperture 215a may receive the first fastener 214a, a second mounting rail aperture 215b may receive the second fastener 214b, a third mounting rail aperture 215c may receive the third fastener 214c, and a fourth mounting rail aperture 215d may receive the fourth fastener 214d to the mounting rail 210.

In some embodiments, the fasteners 214 may be threaded or unthreaded. In some embodiments, threads of the fasteners 214 may include any thread type that allows the threads of the fastener 214 to be threaded together with a corresponding set of threads. For example, the threads of the fastener 214 may be right-hand threads, left-hand threads, unified thread standard (UTS) threads, metric threads, Acme threads, square threads, buttress threads, or any other suitable thread. In these and other embodiments, the mounting rail apertures 215 of the mounting rail 210 may be threaded and may have a corresponding threads to the fasteners 214.

In some embodiments, each clip 212 may include one or more clip apertures 213 that may be sized and configured to receive a fastener 214. For example, as illustrated in FIG. 2D, the first clip 212a may include a first clip aperture 213a that may receive the first fastener 214a, the second clip 212b may include a second clip aperture 213b that may receive the second fastener 214b, the third clip 212c may include a third clip aperture 213c that may receive the third fastener 214c, and the fourth clip 212d may include a fourth clip aperture 213d that may receive the fourth fastener 214d. In some embodiments, the clip apertures 213 may be threaded and may have corresponding threads to the fasteners 214.

FIGS. 2E and 2F respectively illustrate an end-view and a side-view of the example mounting assembly 200 of FIGS. 2A and 2B coupled to the module rails 206 of FIGS. 2A and 2B. With respect to FIGS. 2E and 2F, a clip 212 will be described generically with respect to the mounting assembly 200. As an example operation of the mounting assembly 200, a clip 212 (e.g., the first clip 212a) may be coupled to a fastener 214 (e.g., the first fastener 214a). For example, the fastener 214 may be threaded into a clip aperture 213 (e.g., the first clip aperture 213a) of the clip 212. In some embodiments, after the clip 212 and the fastener 214 are coupled, a retention mechanism 230 may be installed on the fastener 214 to inhibit movement of the clip 212 during installation of the module rails 206. For example, in some embodiments, the retention mechanism 230 may be an O-ring, which may provide frictional resistance in response to the clip 212 being upwardly displaced relative to the mounting rail 210.

As illustrated in FIG. 2E, the clip 212 may include a first surface 222 (e.g., a top surface), a second surface 224 (e.g., a bottom surface) opposite the first surface 222, and an edge 226 extending between the first surface 222 and the second surface 224. The second surface 224 may include a first end protrusion 218a at a first end 232a of the clip 212 and a second end protrusion 218b at a second end 232b of the clip 212. The first end protrusion 218a may be configured to inhibit movement of the first module rail 206a when the clip 212 is coupled to the first module rail 206a. The second end protrusion 218b may be configured to inhibit movement of the second module rail 206b when the clip 212 is coupled to the second module rail 206b.

The second surface 224 may further include a central protrusion 220 positioned between the first end protrusion 218a and the second end protrusion 218b. The central protrusion 220 may be configured to couple the clip 212 to the mounting rail 210. For example, the clip aperture 213 may extend through the first surface 222 and the central protrusion 220 such that the clip 212 may be coupled to the mounting rail 210 via the fastener 214.

In some embodiments and as illustrated in FIG. 2E, the central protrusion 220 may extend farther from the second surface 224 than the first end protrusion 218a and the second end protrusion 218b. As a result, the clip 212 may be positioned higher than the clip 212 would be if the central protrusion 220 extended the same amount as the end protrusions 218. Thus, during installation, the first module rail 206a and/or the second module rail 206b, may be coupled to the mounting rail 210 via the clip 212 without having to lift the clip 212 manually by hand. Consequently, multiple seconds may be saved per clip 212 during the installation of PV modules.

In these and other embodiments, as previously discussed, the clip aperture 213 of the clip 212 may be threaded, and the central protrusion 220 extending farther than the end protrusions 218 may allow the clip aperture 213 to include additional threads, which may increase the torsional resistance of the clip 212. As a result, the clip 212 may be less likely to rotate as a result of applying torque to the fastener 214 and/or as a result of forces experienced during operation of a PV system such as the PV system 100 described with respect to FIG. 1.

A first channel 228a may be defined by the second surface 224 between the first end protrusion 218a and the central protrusion 220. The first channel 228a may be configured to engage an apertural surface of a module rail aperture 208 (e.g., the module rail apertures 208a-208d) of the first module rail 206a. A second channel 228b may be defined by the second surface 224 between the second end protrusion 218b and the central protrusion 220. The second channel 228b may be configured to engage an apertural surface of a module rail aperture 208 (e.g., the module rail apertures 208e-208h) of the second module rail 206b.

The first module rail 206a may be coupled to the mounting rail 210 by aligning the module rail aperture 208 of the first module rail 206a with the first end 232a of the clip 212, and moving the first module rail 206a towards the fastener 214 such that the first end 232a of the clip 212 may be received by the module rail aperture 208 and the bottom of the first module rail 206a may contact a top portion of the mounting rail 210 as illustrated in FIG. 2E. Because the central protrusion 220 may extend further from the second surface 224 than the end protrusions 218, the first module rail 206a may be coupled to the mounting rail 210 without having to manually lift the clip 212 upwards. The second module rail 206b may be coupled to the mounting rail 210 via the second end 232b of the clip 212 in a similar fashion such that the bottom of the second module rail 206b may contact a top portion of the mounting rail 210 as illustrated in FIG. 2E.

The end protrusions 218 may be offset from the bottom of the apertural surface of the module rail apertures 208, which may cause the end protrusions 218 to contact the module rails 206 below the bottom of the apertural surface upon outward movement of the module rails 206 relative to the mounting rail 210.

For example, as illustrated in FIG. 2F, after the module rail aperture 208 of the first module rail 206a receives the first end protrusion 218a, the first end protrusion 218a may be downwardly offset from the bottom of the apertural surface 234 of the module rail aperture 208 of the first module rail 206a. In response to the first module rail 206a moving away from the fastener 214 and/or the mounting rail 210, the first module rail 206a may contact the first end protrusion 218a. As a result, the first end protrusion 218a may inhibit further movement away from the fastener 214 and/or the mounting rail 210.

Thus, the end protrusions 218 may help prevent the bottom of the module rails 206 from slipping off the top portion of the mounting rail 210 during operation of the PV system and/or during weather events such as high-wind events. Consequently, the end protrusions may inhibit module slippage, which may increase the reliability, safety, and efficiency of the PV system.

In some instances, as an end 232 of the clip 212 enters a module rail aperture 208 during installation, the clip 212 may be upwardly displaced towards the retention mechanism 230 due to an end protrusion 218 contacting an apertural surface 234 of the module rail aperture 208. However, after the end protrusion 218 clears the apertural surface 234 of the module rail aperture 208, the clip 212 may be downwardly displaced and a channel 228 of the clip 212 may engage the apertural surface 234 of the module rail aperture 208. For example, as illustrated in FIG. 2F, after the first end protrusion 218a clears the apertural surface 234 of the module rail aperture 208, the clip 212 may be downwardly displaced towards the mounting rail 210 such that the first channel 228a may engage the apertural surface 234 of the module rail aperture 208.

As illustrated in FIG. 2F, in some embodiments, the edge 226 of the clip 212 may taper inwardly from a central portion 236 of the clip 212 to the first end 232a of the clip 212 and may taper inwardly from the central portion 236 of the clip 212 to the second end 232b such that the clip 212 may be narrower at the first end 232a and the second end 232b than at the central portion 236 of the clip 212. In some embodiments, the edge 226 may taper at a constant rate and in some embodiments the edge 226 may taper at a variable rate (e.g., an increasing rate). In some embodiments, the central portion 236 of the clip 212 may include the central protrusion 220. In these and other embodiments, the central portion 236 of the clip 212 may be bounded by the location at which the edge 226 starts to taper inwardly toward the first end 232a on one side and bounded by the location at which the edge 226 starts to taper inwardly toward the second end 232b on another side.

The edge 226 narrowing toward the first end 232a and the second end 232b may provide a guide for the clip 212 to be inserted into the module rail aperture 208. For example, during installation, the module rail aperture 208 of the first module rail 206a may be slightly misaligned with the clip 212 such that the apertural surface 234 contacts the edge 226 as the first module rail 206a is moved toward the fastener 214. Because the edge 226 may be tapered, the apertural surface 234 may be guided along the edge 226 as the first module rail 206a is moved toward the fastener 214. Without the edge 226 being tapered, in some instances, the module rails 206 may need to be realigned before installation continues. Thus, tapering the edge 226 may lead to installation efficiencies and reduce lost time due to realigning the module rails 206 during installation.

Modifications, additions, or omissions may be made to the mounting assembly 200 and/or the module rails 206 without departing from the scope of the present disclosure. For example, a higher number or a lower number of clips 212 may be utilized than that illustrated in FIGS. 2A-2F. For instance, a higher number of clips 212 may be used in more extreme environments in which the clips 212 may experience higher loads (e.g., higher wind environments) and/or a lower number of clips 212 may be used in less extreme environments in which the clips 212 may experience lower loads (e.g., lower wind environments).

Additionally, in some embodiments, the module rails 206 may include a higher number or a lower number of module rail apertures 208. In some embodiments, the number of module rail apertures 208 may be the same as the number of clips 212. In some embodiments, the number of module rail apertures 208 may be different than the number of clips 212 utilized. For example, the number of module rail apertures 208 in each module rail 206 may be higher than the number of clips 212.

In some embodiments, the retention mechanism 230 may be omitted. In some embodiments, the end protrusions 218 may be omitted from the clips 212. In some embodiments, the central protrusion 220 may be omitted from the clips 212.

In some embodiments, the fasteners 214 and/or the clip apertures 213 may be omitted. In these and other embodiments, the clips 212 may be integrated with the mounting rail 210 such that the clips 212 and the mounting rail 210 form a single combined unit. For example, the clips 212 may be welded to the mounting rail 210.

In some embodiments, the clip 212 may be manufactured via forging such as by using the method 400 described with respect to FIG. 4. In some embodiments, the clip 212 may be manufactured via stamping, casting, injection molding, or other suitable manufacturing processes.

In some embodiments, the clip 212 may be manufactured out of metal (e.g., steel, aluminum, cast-iron, or other suitable metals), plastics (e.g., polycarbonate, polyetheretherketone (PEEK), Polybutylene Terephthalate, or other suitable plastics), composites (e.g., carbon fiber or other suitable composites), among other materials.

In some embodiments, the one or more clips 212 may be used at a final PV module in a row of PV modules as the ends of the rows of PV modules may experience the highest forces due to galloping. In these and other embodiments, the clips 212 may not be utilized in the middle of the row and different clips may be used instead.

Furthermore, the components illustrated in FIG. 2A-2F and described with reference to FIG. 2A-2F may be similar to, have similar features as, or perform similar functions as similarly named components described throughout this disclosure. For example, the clips 212 may be similar to the clips described throughout this disclosure.

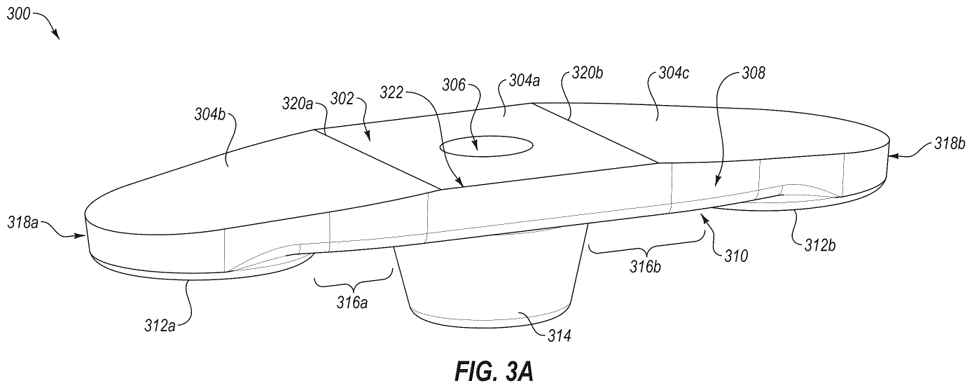

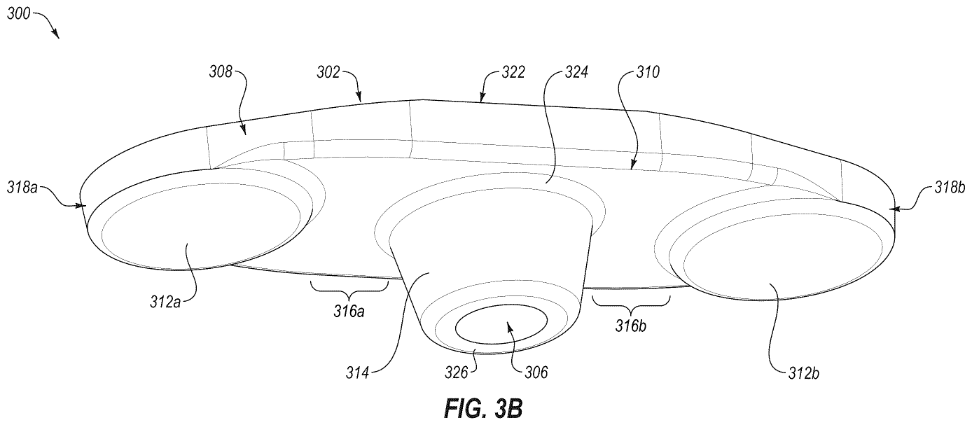

FIG. 3A and FIG. 3B illustrate various perspective views of an example clip 300. The clip 300 may be similar to the clips 212 described with respect to FIGS. 2A-2F, and/or may be utilized in a PV system such as the PV system 100 described with respect to FIG. 1. The example clip 300 may include a first surface 302, a second surface 310 opposite the first surface 302, and an edge 308 extending between the first surface 302 and the second surface 310.

In some embodiments, the second surface 310 may include a first end protrusion 312a at a first end 318a of the clip 300 and/or the second surface 310 may include a second end protrusion 312b at a second end 318b of the clip 300. In some embodiments, the first end 318a and the second end 318b of the clip 300 may respectively correspond to a first end of the second surface 310 and/or a second end of the second surface 310 and/or the first surface 302. As described previously with reference to FIGS. 2A-2F, the first end protrusion 312a may be configured to inhibit movement of a first module rail of a first PV module such as the first module rail 206a, and the second end protrusion 312b may be configured to inhibit movement of a second module rail of a second PV module such as the second module rail 206b.

In some embodiments, the first end protrusion 312a and the second end protrusion 312b may be symmetrical. In some embodiments, as illustrated in FIGS. 3A and 3B, the first end protrusion 312a and the second end protrusion 312b may be rounded. For instance, the first end protrusion 312a and the second end protrusion 312b may be circular (e.g., having a circular cross-section), ovular (e.g., having an ovular cross-section), elliptical (e.g., having an elliptical cross-section), among other rounded shapes. In some embodiments, the end protrusions 312 may be geometrically shaped (e.g., circular, triangular, square, rectangular, pentagonal, hexagonal, heptagonal, octagonal, or any other suitable geometric shape). In some embodiments, the end protrusions 312 may be non-geometrically shaped. In some embodiments, the first end protrusion 312a and the second end protrusion 312b may extend from the second surface 310 by the same amount.

In some embodiments, the first end protrusion 312a and the second end protrusion 312b may be asymmetrical. For example, the first end protrusion 312a and the second end protrusion 312b may be shaped differently and/or may extend from the second surface 310 by different amounts.

In some embodiments, the second surface 310 may include a central protrusion 314 positioned between the first end protrusion 312a and the second end protrusion 312b. As described previously with reference to FIGS. 2A-2F, the central protrusion 314 may be configured to couple the clip 300 to a mounting rail such as the mounting rail 210. In some embodiments, and as illustrated in FIGS. 3A and 3B, the central protrusion 314 may extend farther from the second surface 310 than the end protrusions 312. The central protrusion 314 extending further than the end protrusions 312 may make the clip 300 more resistant to bending forces such as those experienced during galloping as the clip 300 being thicker at the center of the clip 300 than at the ends 318 of the clip 300, which may increase the moment of inertia of the clip 300.

In some embodiments, the central protrusion 314 may be rounded. For example, the central protrusion 314 may be circular (e.g., having a circular cross-section), ovular (e.g., having an ovular cross-section), elliptical (e.g., having an elliptical cross-section), among other rounded shapes. In some embodiments, the central protrusion 314 may be geometrically shaped (e.g., circular, triangular, square, rectangular, pentagonal, hexagonal, heptagonal, octagonal, or any other suitable geometric shape). In some embodiments, the central protrusion 314 may be non-geometrically shaped.

In some embodiments, as illustrated in FIG. 3B, the central protrusion 314 may taper in width from a base 324 of the central protrusion 314 to an end 326 of the central protrusion 314. For example, the central protrusion 314 may be at least partially conical (e.g., having a circular cross-section), and the central protrusion 314 may be wider at the base 324 (e.g., having a larger circular cross-section) than at the end 326 of the central protrusion 314 (e.g., having a smaller circular cross-section).

In some embodiments, the central protrusion 314 may have the same or a similar shape as the end protrusions 312. In some embodiments, the central protrusion 314 may have a different shape than the end protrusions 312. In some embodiments, the central protrusion 314 and the end protrusions 312 may be symmetric or the central protrusion 314 and the end protrusions 312 may be asymmetric.

In some embodiments, a first channel 316a may be defined by the second surface 310 between the first end protrusion 312a and the central protrusion 314, and/or a second channel 316b may be defined by the second surface 310 between the second end protrusion 312b and the central protrusion 314. As described previously with respect to FIGS. 2A-2F, the first channel 316a may be configured to engage an apertural surface of a first module rail of a first PV module such as the first module rail 206a and the second channel 316b may be configured to engage a second apertural surface of a second module rail such as the second module rail 206b. For example, the first module rail may contact the second surface 310 at the first channel 316a between the first end protrusion 312a and the central protrusion 314, and the second module rail may contact the second surface 310 at the second channel 316b between the second end protrusion 312b and the central protrusion 314. In these and other embodiments, the channels 316 may be large enough to allow some movement of the module rails during the operation of a PV system (e.g., the PV system 100), but an inner portion of the end protrusions 312 may inhibit the movement of the module rails towards the ends 318 of the clip 300.

In some embodiments, and as illustrated in FIGS. 3A and 3B, the channels 316 may encompass the space between the end protrusions 312 and the central protrusion 314. In some embodiments, the channels 316 may include recesses in the second surface 310 such that the apertural surface of the module rails may be configured to fit within the recesses.

In some embodiments, the clip 300 may include an aperture 306. In some embodiments, the aperture 306 may be a through hole that extends through the first surface 302 and the second surface 310 between the first end protrusion 312a and the second end protrusion 312b. In some embodiments, the aperture 306 may extend through the first section 304a of the first surface 302. The aperture 306 may be similar to the clip apertures 213 described with respect to FIGS. 2C-2F. For example, in some embodiments, the aperture 306 may extend through the first surface 302 and through the central protrusion 314 as illustrated in FIGS. 3A and 3B.

In some embodiments, the aperture 306 may be threaded. In these and other embodiments, the aperture 306 may be shaped and configured to receive a fastener with corresponding threads to the aperture 306. For example, the aperture 306 may include a first set of threads, which may correspond to the threads of a fastener. For example, the first set of threads of the aperture 306 may be shaped and configured to thread together with the threads of the fastener 214 described with respect to FIGS. 2A-2F. Because the aperture 306 may extend through the first surface 302 and the central protrusion 314, the clip 300 may have increased thread engagement with the fastener such that the clip 300 may be less prone to vibrational loosening and/or unintentional rotation. While not shown in FIG. 3B, threads may extend all, or a portion of, the length of the aperture 306.

In some embodiments, the aperture 306 may be a blind hole. For example, the aperture 306 may extend through the second surface 310 but not the first surface 302.

In some embodiments, as illustrated in FIG. 3A, the first surface 302 may include a first section 304a, a second section 304b that extends from a first end 320a of the first section 304a at a first angle, and a third section 304c that extends from a second end 320b of the first section 304a at a second angle. In some embodiments, the first section 304a may be flat, and the first angle and the second angle may depart downwardly from the first section 304a such that the first end 318a of the clip 300 is lower than the first section 304a of the clip 300 and a second end 318b of the clip 300 is lower than the first section 304a of the clip 300. In some embodiments, the first section 304a of the first surface 302 may correspond to a central portion 322 of the clip 300, which may be similar to the central portion 236 described with respect to FIG. 2F.

In some embodiments, the first angle and the second angle may be the same. In some embodiments, the first angle and the second angle may be different. In some embodiments, the first angle and the second angle may be greater than zero degrees and less than about 45 degrees.

In some embodiments, and as illustrated in FIGS. 3A and 3B, a first thickness between the first section 304a of the first surface 302 and the second surface 310 may be greater than a second thickness between the second section 304b of the first surface 302 and the second surface 310, and/or a third thickness between the third section 304c of the first surface 302 and the second surface 310. In some embodiments, the second and the third thickness may be the same or the second and the third thickness may be different.

In some embodiments, the edge 308 may be a peripheral surface between the first surface 302 and the second surface 310. In some embodiments, the edge 308 may be rounded. For example, edge 308 may be rounded such that the first end 318a and the second end 318b may be curved. The edge 308 being rounded may inhibit damage to the module rails due to the clip 300 rotating.

In some embodiments, the edge 308 may taper inwardly from the central portion 322 of the clip 300 (e.g., the central portion 236 described with respect to FIG. 2F) to the first end 318a, and/or may taper inwardly from the central portion 322 to the second end 318b. As a result, the clip 300 may be narrower at the ends 318 than at the central portion 322 of the clip 300. In these and other embodiments, the ends 318 may serve as a guide to couple the clip 300 to the module rails.

The clip 300 may improve PV systems as the clip 300 may be less prone to failures due to the loads experienced in a PV system such as the PV system 100 of FIG. 1. For example, the clip 300 may be more resistant to loads experienced by the clip 300 during operation of the PV system. In some embodiments, the clip 300 may aid in the retention of module rails on the mounting rail (e.g., preventing module slippage) due to the ability of the end protrusions 312 to inhibit movement of the module rails relative to the mounting rail. In some embodiments, the clip 300 may also help inhibit vibrational loosening of the clip 300 and/or unintentional rotation of the clip 300 due to the increased thread engagement of the aperture 306 when the aperture 306 is threaded. Additionally, the clip 300 may be easier to install, which may result in hours, days, and even weeks of saved labor time.

Modifications, additions, or omissions may be made to the clip 300 without departing from the scope of the present disclosure. For example, in some embodiments, the central protrusion 314 may be omitted. In these and other embodiments, a channel may be defined by the second surface between the first end protrusion 312a and the second end protrusion 312b that may be configured to engage an apertural surface of a first module rail and an apertural surface of a second module rail. In these and other embodiments, the aperture 306 may extend through the first surface 302 and the second surface 310 between the first end protrusion 312a and the second end protrusion 312b.

In some embodiments, the first end protrusion 312a and/or the second end protrusion 312b may be omitted. In these and other embodiments, the central protrusion 314 may be positioned at the central portion 322 of the clip 300.

In some embodiments, the clip 300 may be manufactured via forging such as by the method 400 described with respect to FIG. 4. In some embodiments, the clip 300 may be manufactured via stamping, casting, injection molding, or other suitable manufacturing processes.

In some embodiments, the clip 300 may be manufactured out of metal (e.g., steel, aluminum, cast-iron, or other suitable metals), plastics (e.g., polycarbonate, PEEK, Polybutylene Terephthalate, or other suitable plastics), composites (e.g., carbon fiber or other suitable composites), among other materials.

Furthermore, the components illustrated in FIGS. 3A and 3B and described with reference to FIGS. 3A and 3B may be similar to, have similar features as, or perform similar functions as similarly named components described throughout this disclosure. For example, the clip 300 may be similar to the clips described throughout this disclosure.

FIG. 4 illustrates a flowchart of an example method 400 of manufacturing a clip for coupling a mounting rail to PV modules, in accordance with one or more embodiments of the present disclosure. The method 400 may be performed by any suitable system or device. The method 400 may be used to manufacture the clips described throughout this disclosure. For example, the method 400 may be used to manufacture the clips 212 described with respect to FIGS. 2A-2F and/or the clip 300 described with respect to FIGS. 3A and 3B. Although illustrated with discrete blocks, the steps and operations associated with one or more blocks of the method 400 may be divided into additional blocks, combined into fewer blocks, or eliminated, depending on the particular implementation.

The method 400 may include, at block 410, obtaining a workpiece. In some embodiments, the workpiece may be a metal workpiece. In some embodiments, the metal workpiece may be made from carbon steel, a steel alloy, and/or stainless steel, among other metals. In some embodiments, the metal workpiece may be a steel sheet. In some embodiments, the steel sheet may be made from steel with a minimum yield strength of between about 30,000 psi and about 80,000 psi.

The method 400 may include, at block 420, heating the workpiece to a forging temperature. For example, a workpiece such as a steel sheet may be heated to a temperature at which the workpiece may be plastically deformed without the workpiece losing the ability to maintain a shape once deformed. For instance, the forging temperature of the steel sheet may be between about 1,750 °F to about 2,200 °F.

The method 400 may include, at block 430, applying a compressive force to the workpiece via one or more dies to shape the workpiece into a clip. The clip may be similar to the clips described throughout this disclosure.

In these and other embodiments, the clip may include a first surface, a second surface opposite the first surface, and an edge extending between the first surface and the second surface. In these and other embodiments, the second surface may include a first end protrusion at a first end of the second surface and a second end protrusion at a second end of the second surface. The first end protrusion may be configured to inhibit movement of a first module rail of a first PV module and the second end protrusion may be configured to inhibit movement of a second module rail of a second PV module. In some embodiments, the second surface of the clip may include a central protrusion positioned between the first end protrusion and the second end protrusion, the central protrusion configured to couple to clip to a mounting rail. In some embodiments, a first channel may be defined by the second surface between the first end protrusion and the central protrusion, and the first channel may be configured to engage a first apertural surface of the first module rail. In some embodiments, a second channel may be defined by the second surface between the second end protrusion and the central protrusion, and the second channel may be configured to engage a second apertural surface of the second module rail.

Modifications, additions, or omissions may be made to the method 400 without departing from the scope of the disclosure. For example, the designations of different elements in the manner described is meant to help explain concepts described herein and is not limiting. Further, the method 400 may include any number of other elements or may be implemented within other systems or contexts than those described.

For example, in some embodiments, the workpiece may be plastic, composite, or any other suitable material. In these embodiments, the workpiece may be heated to the forging temperature based on the material utilized (e.g., plastic, composite, among other materials), and the one or more dies may be utilized to shape the workpiece into the clip.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A clip for coupling a mounting rail to PV modules, the clip comprising:
a first surface;
a second surface opposite the first surface, the second surface including;
a first end protrusion at a first end of the second surface, the first end protrusion configured to inhibit movement of a first module rail of a first PV module when the clip is coupled to the first module rail;
a second end protrusion at a second end of the second surface, the second end protrusion configured to inhibit movement of a second module rail of a second PV module when the clip is coupled to the second module rail; and
a central protrusion positioned between the first end protrusion and the second end protrusion, the central protrusion configured to couple the clip to the mounting rail;
a first channel defined by the second surface between the first end protrusion and the central protrusion, the first channel configured to engage a first apertural surface of the first module rail when the clip is coupled to the first module rail;
a second channel defined by the second surface between the second end protrusion and the central protrusion, the second channel configured to engage a second apertural surface of the second module rail when the clip is coupled to the second module rail;
an edge extending between the first surface and the second surface; and
an aperture extending through the first surface and through the central protrusion of the second surface.

2. The clip of claim 1, wherein the first surface comprises:
a first section, the aperture extending through the first section;
a second section that extends from a first end of the first section at a first angle; and
a third section that extends from a second end of the first section at a second angle.

3. The clip of claim 2, wherein the first angle and the second angle are the same.

4. The clip of claim 2, wherein a first thickness between the first section of the first surface and the second surface is greater than a second thickness between the second section of the first surface and the second surface and a third thickness between the third section of the first surface and the second surface.

5. The clip of claim 1, wherein the first end protrusion, the second end protrusion, and the central protrusion are rounded.

6. The clip of claim 5, wherein the first end protrusion, the second end protrusion, and the central protrusion are circular.

7. The clip of claim 5, wherein the central protrusion tapers in width from a base of the central protrusion to a first end of the central protrusion.

8. The clip of claim 1, wherein the central protrusion extends farther from the second surface than the first end protrusion and the second end protrusion.

9. The clip of claim 1, wherein the edge is rounded.

10. The clip of claim 1, wherein the first end protrusion and the second end protrusion are symmetrical.

11. The clip of claim 1, wherein the aperture is a threaded and configured to receive a fastener with corresponding threads to the aperture.

12. The clip of claim 1, wherein the edge tapers inwardly from a central portion of the clip to a first end of the clip and tapers inwardly from the central portion of the clip to a second end of the clip that is opposite the first end of the clip such that the clip is narrower at the first end and the second end than at the central portion of the clip.

13. A PV system comprising:
a first PV module, the first PV module including:
a first solar panel; and
a first module rail coupled to the first solar panel, the first module rail having a first aperture;
a second PV module, the second PV module including:
a second solar panel; and
a second module rail coupled to the second solar panel, the second module rail having a second aperture;
a mounting rail coupled to the first PV module and the second PV module, the mounting rail coupled to a fastener; and
a clip coupling the mounting rail to the first module rail of the first PV module via the first aperture and to the second module rail of the second PV module via the second aperture, the clip comprising:
a first surface;
a second surface opposite the first surface, the second surface including;
a first end protrusion at a first end of the second surface, the first end protrusion configured to inhibit movement of the first module rail;
a second end protrusion at a second end of the second surface, the second end protrusion configured to inhibit movement of the second module rail; and
a central protrusion positioned between the first end protrusion and the second end protrusion;
a first channel defined by the second surface between the first end protrusion and the central protrusion, the first channel configured to engage a first apertural surface of the first aperture;
a second channel defined by the second surface between the second end protrusion and the central protrusion, the second channel configured to engage a second apertural surface of the second aperture;
an edge extending between the first surface and the second surface; and
a third aperture extending through the first surface and through the central protrusion of the second surface, the third aperture coupled to the fastener.

14. The PV system of claim 13, wherein the first surface of the clip comprises:
a first section, the first aperture extending through the first section;
a second section that extends from a first end of the first section at a first angle; and
a third section that extends from a second end of the first section at a second angle.

15. The PV system of claim 14, wherein a first thickness between the first section of the first surface and the second surface is greater than a second thickness between the second section of the first surface and the second surface and a third thickness between the third section of the first surface and the second surface.

16. The PV system of claim 13, wherein the first end protrusion, the second end protrusion, and the central protrusion are rounded and the edge is rounded.

17. The PV system of claim 13, wherein the first end protrusion and the second end protrusion are symmetrical.

18. The PV system of claim 13, wherein the third aperture is threaded with a first set of threads and the fastener has a corresponding set of threads to the first set of threads.

19. The PV system of claim 13, wherein the edge tapers inwardly from a central portion of the clip to a first end of the clip and tapers inwardly from the central portion of the clip to a second end of the clip that is opposite the first end of the clip such that the clip is narrower at the first end and the second end than at the central portion of the clip.

20. A PV system comprising:
a mounting rail configured to be coupled to a first module rail of a first PV module and a second module rail of a second PV module, the mounting rail coupled to a fastener; and
a clip configured to couple the mounting rail to a first module rail via a first aperture in the first module rail and to the second module rail via a second aperture in the second module rail, the clip comprising:
a first surface;
a second surface opposite the first surface, the second surface including;
a first end protrusion at a first end of the second surface, the first end protrusion configured to inhibit movement of the first module rail when the clip is coupled to the first module rail;
a second end protrusion at a second end of the second surface, the second end protrusion configured to inhibit movement of the second module rail when the clip is coupled to the second module rail;
a central protrusion positioned between the first end protrusion and the second end protrusion;
a first channel defined by the second surface between the first end protrusion and the central protrusion, the first channel configured to engage a first apertural surface of the first aperture when the clip is coupled to the first module rail;
a second channel defined by the second surface between the second end protrusion and the central protrusion, the second channel configured to engage a second apertural surface of the second aperture when the clip is coupled to the second module rail;
an edge extending between the first surface and the second surface; and
a third aperture extending through the first surface and through the central protrusion of the second surface, the third aperture coupled to the fastener.
